(19) United States
(12) Patent Application Publication
(10) Pub. No.: US 2017/0106517 A1
(43) Pub. Date: Apr. 20, 2017

(54) IMPACT TOOL

(71) Applicant: MAKITA CORPORATION, Anjo-shi, Aichi (JP)

(72) Inventor: Yoshitaka MACHIDA, Anjo-shi (JP)

(73) Assignee: MAKITA CORPORATION, Anjo-shi, Aichi (JP)

(21) Appl. No.: 15/318,152

(22) PCT Filed: Jun. 2, 2015
(86) PCT No.: PCT/JP2015/065950

§ 371 Date: Dec. 12, 2016

(30) Foreign Application Priority Data
Jun. 12, 2014 (JP) 2014-121723

(51) Int. Cl. B25D 11/10; B25D 17/24; B25D 16/00

(52) U.S. Cl. CPC B25D 11/102; B25D 16/00; B25D 17/24; B25D 2211/062; B25D 2217/0073

(57) ABSTRACT

A hammer drill has a body housing having a motor housing and a gear housing formed in one piece. An electric motor is fixed to the motor housing. A motion converting mechanism, a striking mechanism and a tool holder which form a striking mechanism part are housed in the gear housing so as to be movable with respect to the gear housing. During hammering operation, the striking mechanism part moves with respect to the gear housing under a biasing force of a coil spring, so that vibration caused by the hammering operation is reduced.

### TECHNICAL FIELD

The present invention relates to an impact tool for performing an operation on a workpiece.

### BACKGROUND ART

WO2007/039356 discloses an electric machine tool having a striking mechanism. In this electric machine tool, a housing shell in which an electric motor is housed and a housing shell in which the striking mechanism is housed are separately arranged from each other. The two housing shells form an outer shell of the electric machine tool. The two housing shells are connected to each other via a compression spring, so that they can move with respect to each other.

### SUMMARY OF THE INVENTION

### Problems to be Solved by the Invention

Generally, in order to hold an impact tool with stability when performing a hammering operation with the impact tool, a user holds a front region of the impact tool with one hand and holds a rear region of the impact tool with the other hand. In the above-described electric machine tool, however, the front housing shell and the rear housing shell which are held with the respective hands of the user move with respect to each other, so that the distance between the hands holding the impact tool fluctuates during hammering operation. Operability of the impact tool may be impaired by fluctuations of the distance between the hands. Therefore, further improvement is required in this point.

Accordingly, it is an object of the present invention to provide an improved technique for enhancing operability of an impact tool.

### Representative Embodiments to Solve the Problem

The above-described problem is solved by the present invention. According to a preferred aspect of the present invention, an impact tool is provided which performs a hammering operation by driving a detachable tool accessory at least in an axial direction of the tool accessory. The impact tool has a motor, a driving mechanism that is driven by the motor and drives the tool accessory in the axial direction of the tool accessory, a single body housing that has a motor housing region for housing the motor and a driving mechanism housing region for housing the driving mechanism, and a biasing member that is disposed between the driving mechanism and the body housing. The motor is fixedly held in the motor housing region by a motor holding member. The motor holding member typically includes a fastening means such as a screw and a bolt. Further, the driving mechanism is held in the driving mechanism housing region by a driving mechanism holding member so as to be movable with respect to the body housing. The “single housing” means that the motor housing region for housing the motor and the driving mechanism housing region for housing the driving mechanism are integrally configured so as not to be movable with respect to each other. Therefore, the motor housing region and the driving mechanism housing region may be separately formed and fixedly connected to each other to form the single housing. A spring element such as a coil spring is typically used as the biasing member.

The driving mechanism moves with respect to the body housing under a biasing force of the biasing member, so that transmission of vibration from the driving mechanism to the body housing is reduced. In order to generate a striking force on the workpiece by driving the tool accessory in its axial direction, the driving mechanism suitably includes a motion converting mechanism for converting rotation of the motor into linear motion and a striking mechanism for striking the tool accessory by linear motion. Typically, it is configured such that only the driving mechanism in which vibration is caused during hammering operation moves with respect to the body housing and vibration of the driving mechanism is reduced by elastic deformation of the biasing member. During hammering operation, since the tool accessory is pressed against the workpiece, a reaction force is applied from the workpiece to the driving mechanism in a direction from a tip to a base end of the tool accessory in the axial direction of the tool accessory. Therefore, typically, it is configured such that the biasing member biases the driving mechanism toward the tip of the tool accessory.

According to the present invention, an internal mechanism or the driving mechanism moves with respect to the body housing configured as the single housing. With such a structure, vibration of the driving mechanism caused during hammering operation is suppressed by the biasing force of the biasing member. Therefore, transmission of vibration from the driving mechanism to the body housing is suppressed. Further, the distance between the hands of the user holding the body housing configured as the single housing does not fluctuate. Thus, operability of the impact tool is improved in comparison to the prior art impact tool in which a region for housing the motor and a region for housing the driving mechanism move with respect to each other.

According to a further aspect of the impact tool of the present invention, the driving mechanism holding member has a guide member that extends in parallel to the axial direction of the tool accessory and is fixed in the driving mechanism housing region. The guide member guides the driving mechanism such that the driving mechanism moves in the axial direction of the tool accessory with respect to the body housing. Preferably, the guide member is formed as an elongate guide shaft. The biasing member is formed as a coil spring which is arranged coaxially with the guide member so as to overlap with at least part of the guide member in a longitudinal direction of the guide member. The shape of the guide shaft suitably includes a cylindrical shape and a prismatic shape. Preferably, the guide member consists of a plurality of guide elements which are arranged substantially symmetrically with respect to an axis of the tool accessory. During hammering operation, the tool accessory is pressed against the workpiece, so that vibration is caused mainly in the axial direction of the tool accessory in the impact tool. With the structure in which the driving mechanism is guided to move in the axial direction of the tool accessory by the guide member, the driving mechanism moves with respect to the body housing under the biasing force, so that vibration caused during hammering operation is effectively reduced. Further, the guide member is provided as a member not only to guide the driving mechanism, but also to define the direction of expansion and contraction of the biasing member or the coil spring.

According to a further aspect of the impact tool of the present invention, the driving mechanism has a swinging member that is driven by the motor and caused to swing in the axial direction of the tool accessory, and a striking mechanism that drives the tool accessory in the axial direction by swinging motion of the swinging member and performs the hammering operation. Further, the body housing has an intermediate shaft that is rotationally driven by the motor to drive the swinging member, arranged in parallel to the axial direction of the tool accessory and supported so as not to be movable in the axial direction of the tool accessory with respect to the body housing. The swinging member is held so as to be movable in the axial direction of the tool accessory with respect to the intermediate shaft. Further, the intermediate shaft guides the swinging member such that the swinging member moves in the axial direction of the tool accessory with respect to the body housing. The swinging member may be guided by the intermediate shaft by contact with the intermediate shaft, or it may be guided by the intermediate shaft via a holding member which is provided to define the position of the swinging member with respect to the intermediate shaft.

Preferably, the holding member is provided which holds the swinging member while being spaced apart from the intermediate shaft in a radial direction of the intermediate shaft and can move in the axial direction of the tool accessory together with the swinging member with respect to the body housing. The impact tool further has a rotation transmitting member that rotates together with the intermediate shaft and can come in and out of contact with the swinging member by sliding in the axial direction of the tool accessory with respect to the intermediate shaft. The rotation transmitting member comes in contact with the swinging member to drive the swinging member and transmits rotation of the intermediate shaft to the swinging member. More preferably, the rotation transmitting member can slide in the axial direction of the tool accessory together with the swinging member with respect to the intermediate shaft while maintaining a state in which the rotation transmitting member can transmit rotation of the intermediate shaft to the swinging member by contact with the swinging member.

Further, in addition to the driving mechanism that drives the tool accessory in the axial direction, the impact tool may have a rotation transmitting mechanism that rotationally drives the tool accessory around its axis. In this case, the driving mechanism causes the tool accessory to perform a hammering operation and a rotation transmitting mechanism causes the tool accessory to perform a drilling operation. Specifically, a hammer drill is provided as the impact tool in which the hammering operation and the drilling operation are performed according to a selected drive mode. In such a hammer drill, by providing the rotation transmitting member which can come in and out of contact with the swinging member, the rotation transmitting member forms a drive mode switching mechanism which switches between the drive mode for performing the hammering operation and the drive mode for performing the drilling operation.

According to a further aspect of the present invention, the impact tool has a tool accessory holding member that holds the tool accessory. The driving mechanism has a holding member that holds the tool accessory holding member via a first bearing, holds the swinging member via a second bearing and can move in the axial direction of the tool accessory together with the tool accessory holding member and the swinging member with respect to the body housing. Specifically, the holding member holds the tool accessory holding member and the swinging member so as to keep the distance between the tool accessory holding member and the swinging member constant. Further, preferably, the guide member is configured to guide the holding member. Typically, a guide hole through which the guide shaft is inserted is formed in the holding member. The driving mechanism which moves with respect to the body housing is formed in one piece (in the form of an assembly) by the holding member, so that the driving mechanism is stably moved. Moreover, the assembly of the driving mechanism can be easily mounted to the body housing.

According to a further aspect of the impact tool of the present invention, a cushioning member is provided between the body housing and the driving mechanism. The cushioning member may be suitably mounted to either or both of the body housing and the driving mechanism. When the driving mechanism moves with respect to the body housing, the cushioning member avoids direct collision between the body housing and the driving mechanism and cushions impact caused by (indirect) collision between the body housing and the driving mechanism via the cushioning member.

According to a further aspect of the present invention, the impact tool has a handle (also referred to as a main handle) which is immovably connected to the body housing and designed to be held by the user. Further, an auxiliary handle mounting part to which a removable auxiliary handle is mounted is formed in the body housing. With the structure in which the distance between the auxiliary handle mounted to the body housing and the main handle is kept constant, operability for a user is improved.

According to a further aspect of the impact tool of the present invention, the motor is arranged such that a rotation axis of the motor extends in parallel to the axis of the tool accessory. Further, one end of a driving shaft of the motor engages with the driving mechanism in order to drive the driving mechanism. The driving shaft is preferably arranged in parallel to the axis of the tool accessory such that one end of the driving shaft is arranged close to the tool accessory and the other end is arranged apart from the tool accessory. More preferably, like the driving shaft of the motor, the intermediate shaft is also arranged in parallel to the axis of the tool accessory.

### Effect of the Invention

According to the present invention, an improved technique for enhancing operability of an impact tool is provided.

Other objects, features and advantages of the present invention will be readily understood after reading the following detailed description together with the accompanying drawings and the claims.

### BRIEF DESCRIPTION OF THE DRAWINGS

FIG. 1 is a sectional view showing an overall structure of a hammer drill according to an embodiment of the present invention.

FIG. 2 is an enlarged sectional view showing an internal mechanism of the hammer drill.

FIG. 3 is a sectional view taken along line in FIG. 1.

FIG. 4 is a sectional view taken along line IV-IV in FIG. 3.

FIG. 5 is a sectional view taken along line V-V in FIG. 3.

FIG. 6 is a view showing an operation mode switching mechanism when an eccentric shaft is located in an intermediate position.

FIG. 7 is a view showing the operation mode switching mechanism when the eccentric shaft is located in a rear position.

FIG. 8 is a view showing the operation mode switching mechanism when the eccentric shaft is located in a front position.

FIG. 9 is a sectional view showing a state in which a striking mechanism part has been moved rearward in the hammer drill of FIG. 1.

FIG. 10 is a sectional view showing a state in which the striking mechanism part has been moved rearward in the hammer drill of FIG. 4.

FIG. 11 is a sectional view showing a state in which the striking mechanism part has been moved rearward in the hammer drill of FIG. 5.

FIG. 12 is a view showing a state in which a rotary body of FIG. 6 has been moved rearward.

FIG. 13 is a view showing a state in which the rotary body of FIG. 7 has been moved rearward.

FIG. 14 is a view showing a state in which the rotary body of FIG. 8 has been moved rearward.

### EMBODIMENTS FOR CARRYING OUT THE INVENTION

Each of the additional features and method steps disclosed above and below may be utilized separately or in conjunction with other features and method steps to provide improved impact tools and devices utilized therein. Representative examples of this invention, which examples utilized many of these additional features and method steps in conjunction, will now be described in detail with reference to the drawings. This detailed description is merely intended to teach a person skilled in the art further details for practicing preferred aspects of the present teachings and is not intended to limit the scope of the invention. Only the claims define the scope of the claimed invention. Therefore, combinations of features and steps disclosed within the following detailed description may not be necessary to practice the invention in the broadest sense, and are instead taught merely to particularly describe some representative examples of the invention, which detailed description will now be given with reference to the accompanying drawings.

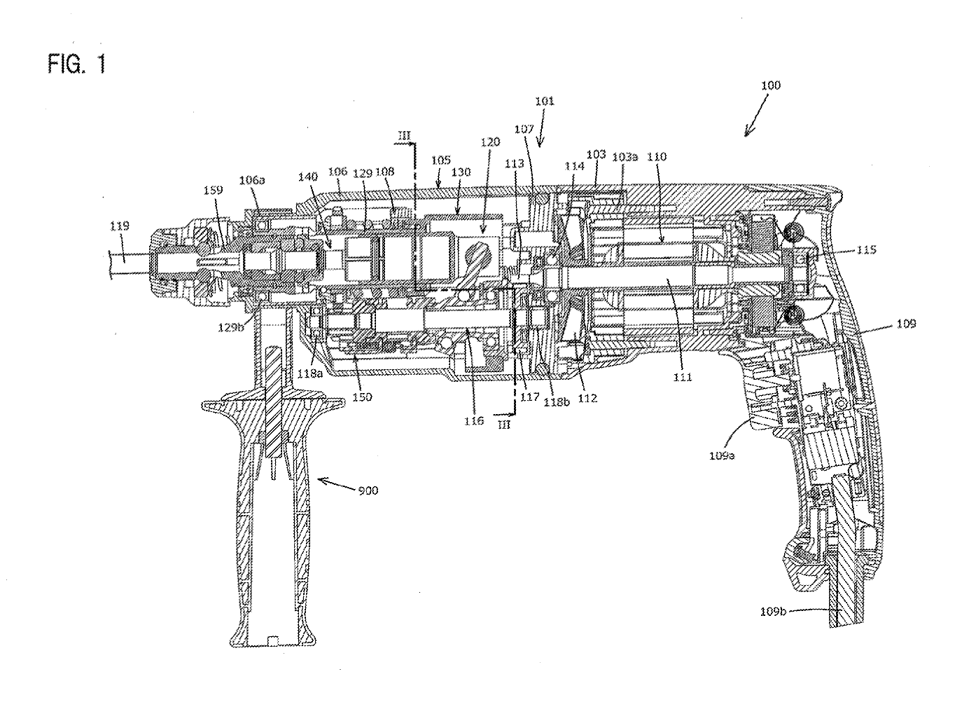

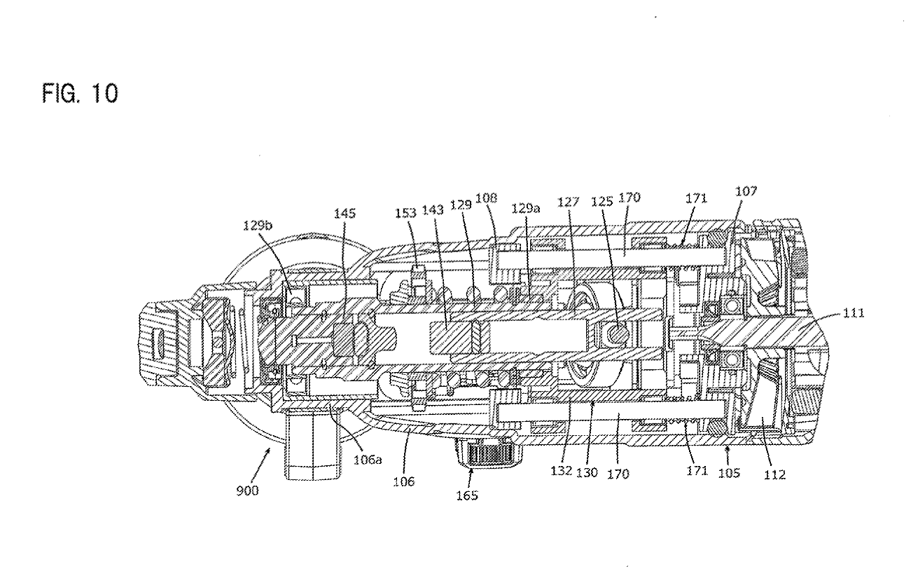

A representative embodiment of the present invention is now explained with reference to FIGS. 1 to 14. In this embodiment, a hand-held hammer drill is described as a representative example of an impact tool according to the present invention. As shown in FIG. 1, a hammer drill 100 is a hand-held impact tool for performing a chipping operation and a drilling operation on a workpiece (such as concrete) by causing a hammer bit 119 to perform hammering motion in its axial direction and rotating motion around its axis. The hammer bit 119 is an example embodiment that corresponds to the “tool accessory” according to the present invention.

[Overall Structure of the Hammer Drill]

As shown in FIG. 1, the hammer drill 100 mainly includes a body housing 101 that forms an outer shell of the hammer drill 100. The hammer bit 119 is removably coupled to a front end region of the body housing 101 via a cylindrical tool holder 159. The hammer bit 119 is inserted into a bit insertion hole of the tool holder 159 and held such that it is allowed to reciprocate in its axial direction and prevented from rotating around its axis with respect to the tool holder 159. Further, the axis of the tool holder 159 coincides with the axis of the hammer bit 119.

The body housing 101 mainly includes a motor housing 103 and a gear housing 105. A handgrip 109 designed to be held by a user is connected to the motor housing 103 on the side of the body housing 101 opposite to the hammer bit 119 in the axial direction of the hammer bit 119. For the sake of explanation, the hammer bit 119 side and the handgrip 109 side are defined as a front side and a rear side, respectively, in the axial direction of the hammer bit 119 (the longitudinal direction of the body housing 101, a horizontal direction as viewed in FIG. 1).

The body housing 101 has the gear housing 105 on its front side and the motor housing 103 behind the gear housing 105 in the axial direction of the hammer bit 119. Further, the handgrip 109 is connected to a rear end of the motor housing 103. The motor housing 103 and the gear housing 105 are fixedly connected to each other by a fastening means such as screws so as not to move with respect to each other. Thus, the single body housing 101 is formed. Specifically, the motor housing 103 and the gear housing 105 are formed as separate housings in which respective internal mechanisms are mounted, and integrally connected together by the fastening means to form the single body housing 101. The motor housing 103 and the gear housing 105 are example embodiments that correspond to the “motor housing region” and the “driving mechanism housing region”, respectively, according to the present invention. Further, the body housing 101 is an example embodiment that corresponds to the “body housing” according to the present invention.

As shown in FIG. 1, the motor housing 103 houses an electric motor 110. The electric motor 110 is arranged such that an output shaft 111 extends in parallel to the axis of the hammer bit 119. Further, the electric motor 110 is fixed to the motor housing 103 by the fastening means or screws 103a. The screw 103a is an example embodiment that corresponds to the “motor holding member” according to the present invention. A motor cooling fan 112 is mounted to a front end region of the output shaft 111 and rotates together with the output shaft 111. A pinion gear 113 is provided on the output shaft 111 in front of the fan 112. A front bearing 114 is provided between the pinion gear 113 and the fan 112, and a rear bearing 115 is provided on a rear end of the output shaft 111. With such a structure, the output shaft 111 is rotatably supported by the bearings 114, 115. Further, the front bearing 114 is held by a bearing support part 107 which forms part of the gear housing 105, and the rear bearing 115 is held by the motor housing 103. Therefore, the electric motor 110 is held such that the pinion gear 113 protrudes into the gear housing 105. The electric motor 110 is an example embodiment that corresponds to the “motor” according to the present invention. Further, the pinion gear 113 is typically formed as a helical gear.

As shown in FIG. 1, the handgrip 109 is provided to extend in a direction crossing the axial direction of the hammer bit 119. The handgrip 109 is formed in a cantilever form having a base end connected to the motor housing 103. The handgrip 109 is an example embodiment that corresponds to the “handle” according to the present invention. A trigger 109a for turning on and off the electric motor 110 is provided on the front side of a base end region of the handgrip 109. Further, a power cable 109b for supplying current from an external power source to the electric motor 110 is mounted to a distal end of the handgrip 119. For the sake of explanation, in an extending direction of the handgrip 109 (a vertical direction as viewed in FIG. 1), the base end side of the handgrip 109 is defined as an upper side of the hammer drill 100 and the distal end side of the handgrip 109 is defined as a lower side of the hammer drill 100.

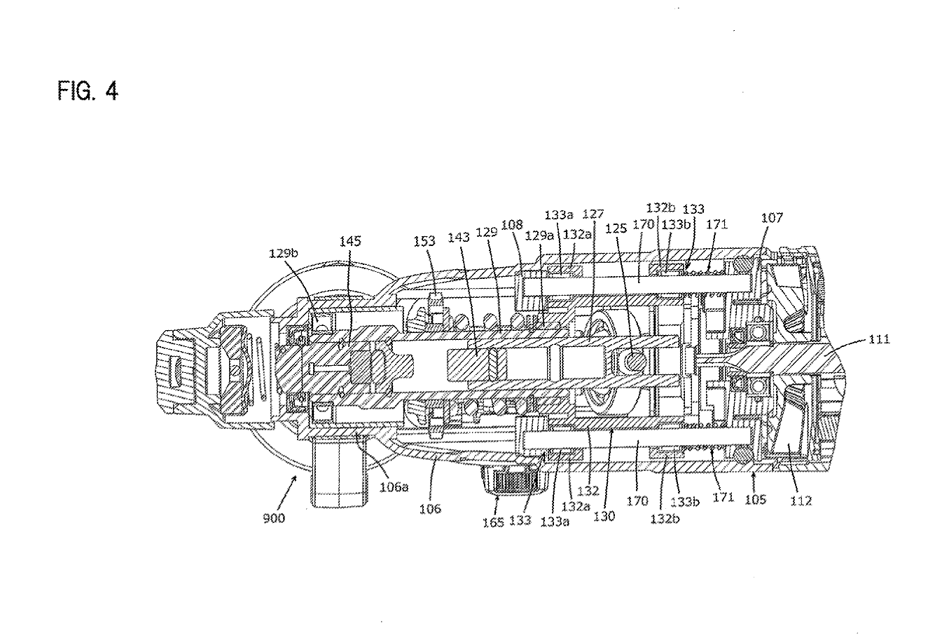

As shown in FIG. 1, the gear housing 105 mainly includes a housing part 106, a bearing support part 107 and a guide support part 108. The housing part 106 forms an outer shell of a front region of the hammer drill 100 (the body housing 101) and has a barrel part 106a, on its front end region, to which an auxiliary handle 900 is removably attached. The barrel part 106a is an example embodiment that corresponds to the “auxiliary handle mounting part” according to the present invention. The bearing support part 107 and the guide support part 108 are fixedly mounted to an inner surface of the housing part 106. The bearing support part 107 supports the bearing 114 for holding the output shaft 111 of the electric motor 110 and a bearing 118b for holding an intermediate shaft 116. The guide support part 108 is disposed substantially in a middle region of the gear housing 105 in the longitudinal direction of the hammer drill 100 and supports a front end of a guide shaft 170 (see FIG. 4) for guiding a striking mechanism part. Further, a rear end of the guide shaft 170 is supported by the bearing support part 107.

As shown in FIG. 1, the gear housing 105 houses a motion converting mechanism 120, a striking mechanism 140, a rotation transmitting mechanism 150 and the tool holder 159. Rotating output of the electric motor 110 is converted into linear motion by the motion converting mechanism 120 and transmitted to the striking mechanism 140. Then the hammer bit 119 held by the tool holder 159 is linearly driven in its axial direction via the striking mechanism 140, so that a hammering operation is performed in which the hammer bit 119 strikes the workpiece. Further, the rotation transmitting mechanism 150 reduces the speed of the rotating output of the electric motor 110 and transmits it to the hammer bit 119, so that the hammer bit 119 is rotationally driven in a circumferential direction around its axis. Thus, the hammer bit 119 performs a drilling operation on the workpiece.

The intermediate shaft 116 is mounted to the gear housing 105 and rotationally driven by the electric motor 110. The intermediate shaft 116 is rotatably supported with respect to the gear housing 105 via a front bearing 118a mounted to the housing part 106 and a rear bearing 118b mounted to the bearing support part 107. Further, the intermediate shaft 116 cannot be moved in an axial direction of the intermediate shaft 116 (the longitudinal direction of the hammer drill 100) with respect to the gear housing 105. A driven gear 117 which engages with the pinion gear 113 of the electric motor 110 is fitted on a rear end part of the intermediate shaft 116. Like the pinion gear 113, the driven gear 117 is also formed as a helical gear. With such a structure, the intermediate shaft 116 is rotationally driven by the output shaft 111 of the electric motor 110. By engagement between the helical gears, noise caused in rotation transmission between the pinion gear 113 and the driven gear 117 is suppressed. The intermediate shaft 116 is an example embodiment that corresponds to the “intermediate shaft” according to the present invention.

[Structure of the Striking Mechanism Part]

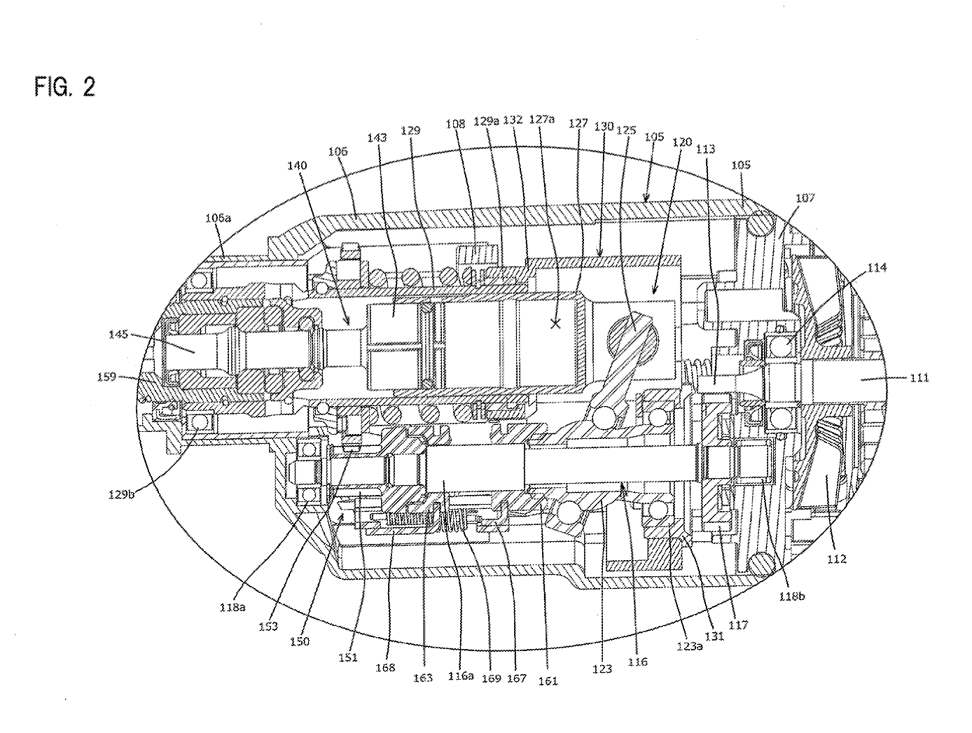

As shown in FIG. 2, the striking mechanism part which drives the hammer bit 119 for hammering operation of the hammer bit 119 mainly includes the motion converting mechanism 120, the striking mechanism 140 and the tool holder 159. The motion converting mechanism 120 mainly includes a rotary body 123 that is disposed on an outer periphery of the intermediate shaft 116, a swinging shaft 125 that is mounted to the rotary body 123, a piston 127 that is connected to a front end part of the swinging shaft 125, a cylinder 129 that forms a rear region of the tool holder 159 and houses the piston 127, and a holding member 130 that holds the rotary body 123 and the cylinder 129. The holding member 130 is an example embodiment that corresponds to the “holding member” according to the present invention.

As shown in FIG. 2, the rotary body 123 is supported via a bearing 123a by a rotary body holding part 131 that forms part of the holding member 130. The rotary body holding part 131 is a substantially cylindrical member for holding the rotary body 123. The intermediate shaft 116 extends through the rotary body 123 in non-contact therewith. Specifically, the rotary body 123 is held by the rotary body holding part 131 so as to be spaced apart from an outer circumferential surface of the intermediate shaft 116 in a radial direction of the intermediate shaft 116. The rotary body 123 can move together with the rotary body holding part 131 in the axial direction of the intermediate shaft 116 (the longitudinal direction of the hammer drill 100) with respect to the intermediate shaft 116.

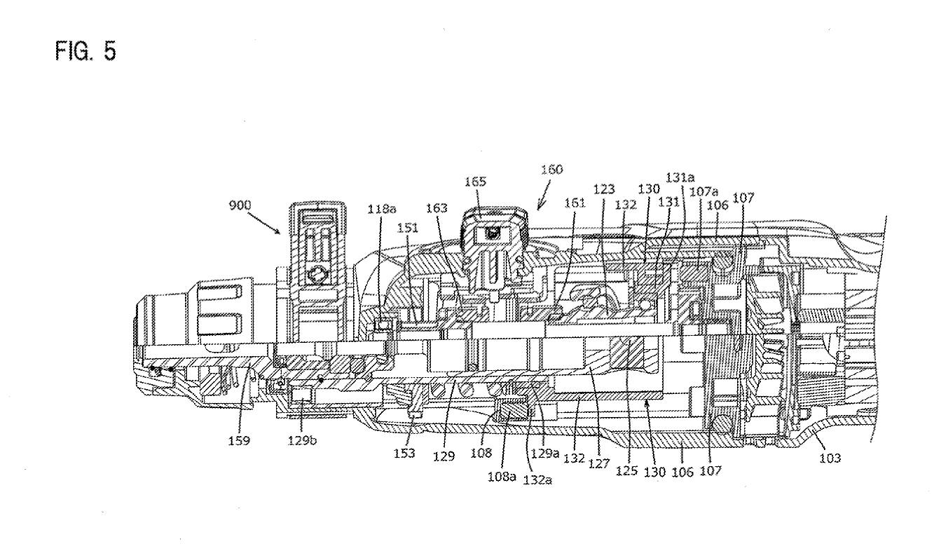

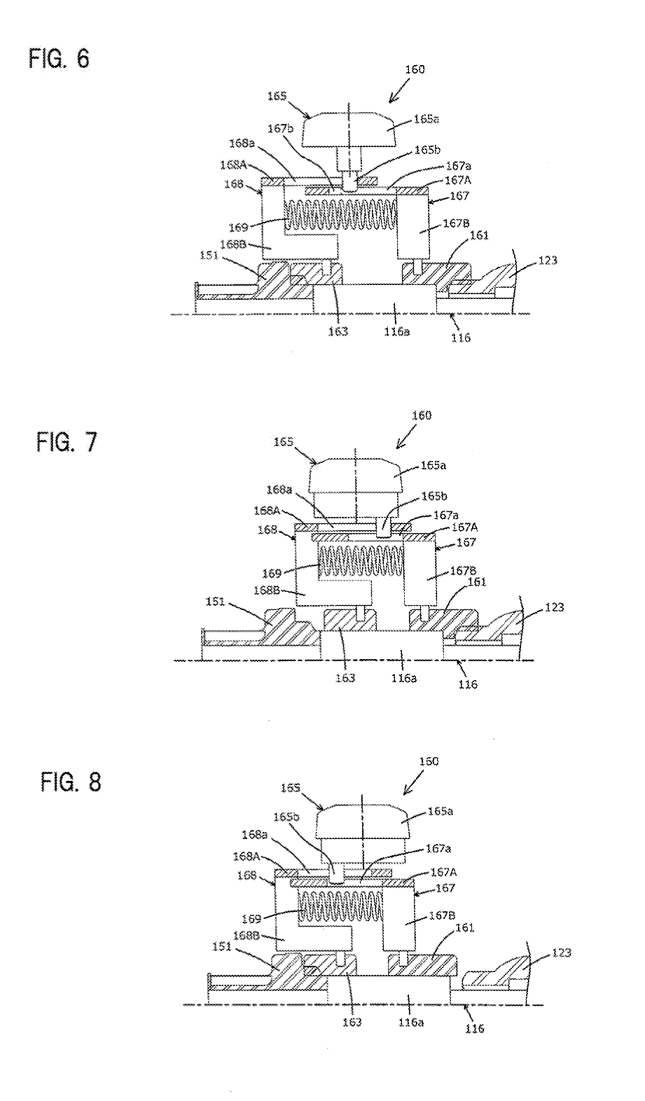

A first rotation transmitting member 161 is disposed on a front side of the rotary body 123. The first rotation transmitting member 161 is substantially cylindrical and has a spline groove formed in its inner circumferential surface. The spline groove has a front region having a small inside diameter and a rear region having a large inside diameter. The front region of the spline groove of the first rotation transmitting member 161 is spline connected to a spline engagement part 116a formed in a substantially middle region of the intermediate shaft 116 which extends through the first rotation transmitting member 161. With such a structure, the first rotation transmitting member 161 is held so as to be slidable in the axial direction of the intermediate shaft 116 (the longitudinal direction of the hammer drill 100) with respect to the intermediate shaft 116 and normally rotates together with the intermediate shaft 116. Further, a rear region of the spline groove of the first rotation transmitting member 161 is configured to be spline connected to an outer circumferential surface of the rotary body 123. By spline connection, the first rotation transmitting member 161 and the rotary body 123 are configured to rotate together and come in and out of contact with each other in the axial direction of the intermediate shaft 116. Specifically, as shown in FIG. 6, when the first rotation transmitting member 161 is located in a rear position, the first rotation transmitting member 161 engages with the rotary body 123 and rotation of the intermediate shaft 116 is transmitted to the rotary body 123, so that the rotary body 123 is rotated around an axis of the intermediate shaft 116. On the other hand, as shown in FIG. 8, when the first rotation transmitting member 161 is located in a front position, the first rotation transmitting member 161 does not engage with the rotary body 123 and rotation of the intermediate shaft 116 is not transmitted to the rotary body 123. The first rotation transmitting member 161 is moved between the front position and the rear position by user's operation of a changeover dial 165. The first rotation transmitting member 161 is an example embodiment that corresponds to the “rotation transmitting member” according to the present invention.

As shown in FIG. 2, the swinging shaft 125 is disposed on an outer periphery of the rotary body 123 and extends upward from the rotary body 123. The rotary body 123 and the swinging shaft 125 form the “swinging member” according to the present invention. A bottomed cylindrical piston 127 is rotatably connected to a front end part (an upper end part) of the swinging shaft 125. Further, the piston 127 can move in the axial direction of the swinging shaft 125 with respect to the swinging shaft 125. Therefore, when rotation of the intermediate shaft 116 is transmitted to the rotary body 123 and the rotary body 123 is rotationally driven, the swinging shaft 125 mounted on the rotary body 123 is caused to swing in the longitudinal direction of the hammer drill 100 (a back-and-forth direction as viewed in FIG. 2). As a result, the piston 127 is caused to linearly reciprocate in the longitudinal direction of the hammer drill 100 within the cylinder 129.

As shown in FIG. 2, a rear end part of the cylinder 129 is supported via a bearing 129a by a cylinder holding part 132 which forms part of the holding member 130. The cylinder holding part 132 is a substantially cylindrical member disposed between a front part of the rotary body 123 and a rear part of the cylinder 129. The cylinder holding part 132 and the rotary body holding part 131 are integrally connected to each other and form the holding member 130 as a single member. Specifically, the rotary body holding part 131 is fixed to an inner circumferential surface of the cylinder holding part 132. The holding member 130 keeps the distance between the rotary body 123 and the cylinder 129 constant. Therefore, when the rotary body 123, the swinging shaft 125 connected to the rotary body 123 and the piston 127 connected to the swinging shaft 125 move in the axial direction of the intermediate shaft 116 (the longitudinal direction of the hammer drill 100) with respect to the intermediate shaft 116, the cylinder 129 also moves in the axial direction of the intermediate shaft 116. Specifically, components of the motion converting mechanism 120 are integrally held (connected) by the holding member 130 and form an assembly (also referred to as a motion converting mechanism assembly).

As shown in FIG. 2, the striking mechanism 140 mainly includes a striking element in the form of a striker 143 that is slidably disposed in the piston 127, and an impact bolt 145 that is disposed in front of the striker 143 and with which the striker 143 collides. Further, a space behind the striker 143 within the piston 127 is defined as an air chamber 127a which functions as an air spring.

When the piston 127 is moved in the back-and-forth direction by swinging movement of the swinging shaft 125, air pressure of the air chamber 127a fluctuates, so that the striker 143 slides in the longitudinal direction of the hammer drill 100 within the piston 127 by the action of the air spring. When the striker 143 is moved forward, the striker 143 collides with the impact bolt 145 and the impact bolt 145 collides with the hammer bit 119 held by the tool holder 159. As a result, the hammer bit 119 is moved forward and performs a hammering operation on the workpiece.

As shown in FIG. 2, the tool holder 159 is a substantially cylindrical member and coaxially and integrally connected with the cylinder 129. In a rear end region of the tool holder 159 connected to the cylinder 129, a bearing 129b is fitted on the cylinder 129. Therefore, the tool holder 159 and the cylinder 129 are supported by the barrel part 106a of the gear housing 105 via the bearing 129b. With such a structure, the tool holder 159 can move together with the cylinder 129 in the axial direction of the hammer bit 119 (the longitudinal direction of the hammer drill 100) and rotate around the axis of the hammer bit 119. The tool holder 159 and the cylinder 129 which are integrally connected to each other are an example embodiment that corresponds to the “tool accessory holding member” according to the present invention. Further, the tool holder 159 and the cylinder 129 are prevented from moving forward by contact with the bearing 129b. The tool holder 159 and the cylinder 129 are held by the cylinder holding part 132 (the holding member 130). Therefore, the motion converting mechanism 120, the striking mechanism 140 and the tool holder 159 are integrally connected by the holding member 130 to form an assembly (also referred to as a striking mechanism assembly).

[Relationship Between the Striking Mechanism Part and the Gear Housing]

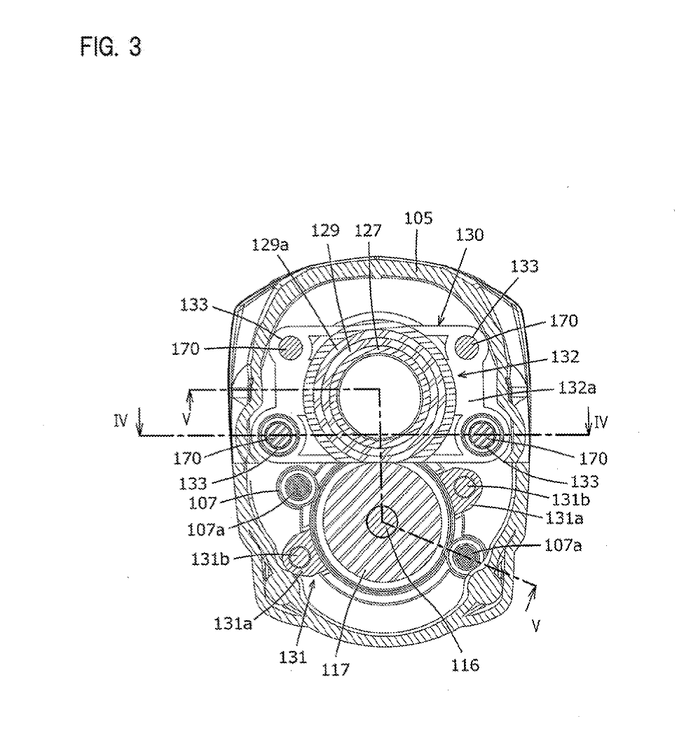

The above-described striking mechanism assembly is movably held in the longitudinal direction of the hammer drill 100 (the axial direction of the hammer bit 119) with respect to the gear housing 105. Specifically, as shown in FIGS. 3 and 4, four guide shafts 170 are mounted to the bearing support part 107 and the guide support part 108. A pair of right and left guide shafts 170 are provided above and below a central axis of the piston 127. As shown in FIG. 3, the right and left guide shafts 170 are symmetrically arranged with respect to a plane including the central axis of the piston 127 and extending in the vertical direction of the hanuner drill 100. As shown in FIG. 4, the guide shafts 170 are arranged to extend in parallel to the axial direction of the hammer bit 119. Further, each of the guide shafts 170 is formed as an elongate member having a circular section, but it may have a polygonal section. The guide shaft 170 is an example embodiment that corresponds to the “driving mechanism holding member” and the “guide member” according to the present invention.

As shown in FIGS. 3 to 5, guide through parts 133 corresponding to the four guide shafts 170 are formed in the cylinder holding part 132 of the holding member 130. As shown in FIGS. 3 and 4, the cylinder holding part 132 has a front flange 132a and a rear flange 132b. As shown in FIG. 4, the guide through parts 133 include front through holes 133a formed in the front flange 132a and rear through holes 133b formed in the rear flange 132b. Further, a bearing for supporting the guide shaft 170 is disposed in each of the through holes 133a, 133b.

As shown in FIG. 4, four coil springs 171 are coaxially fitted onto the respective guide shafts 170 behind the cylinder holding part 132. A front end of each of the coil springs 171 is held in contact with the cylinder holding part 132 and a rear end of the coil spring 171 is held in contact with the bearing support part 107. Specifically, the coil spring 171 is disposed between the motion converting mechanism 120 which is a component of the striking mechanism part, and the gear housing 105. The coil spring 171 normally biases the cylinder holding part 132 forward. In other words, the striking mechanism part (the motion converting mechanism 120, the striking mechanism 140 and the tool holder 159) is held in a front position shown in FIG. 1 by the biasing force of the coil spring 171. The coil spring 171 is an example embodiment that corresponds to the “biasing member” according to the present invention.

As shown in FIG. 5, the guide support part 108 has a cushioning material holding recess, and a front cushioning material 108a made of rubber is disposed in the cushioning material holding recess. A pair of right and left front cushioning materials 108a are disposed on the right and left sides of the piston 127 at a position corresponding to substantially the center of the piston 127 (the cylinder 129) in the vertical direction of the hammer drill 100. Each of the front cushioning materials 108a is arranged to protrude rearward from a rear surface of the guide support part 108 toward the cylinder holding part 132. In other words, the front cushioning material 108a is disposed between the guide support part 108 which forms part of the gear housing 105 and the cylinder holding part 132 which forms part of the striking mechanism part. The front cushioning material 108a is an example embodiment that corresponds to the “cushioning member” according to the present invention.

As shown in FIG. 5, the bearing support part 107 has a cushioning material holding recess, and a first rear cushioning material 107a made of rubber is disposed in the cushioning material holding recess. The first rear cushioning material 107a is arranged to protrude forward from a front surface of the bearing support part 107 toward the rotary body holding part 131. As shown in FIG. 3, two such first rear cushioning materials 107a are symmetrically disposed with respect to the axis of the intermediate shaft 116 in a section perpendicular to the axis of the intermediate shaft 116. The first rear cushioning material 107a is an example embodiment that corresponds to the “cushioning member” according to the present invention.

Further, as shown in FIG. 5, the rotary body holding part 131 has a cushioning material holding part 131a, and a second rear cushioning material 131b made of rubber is disposed in the cushioning material holding part 131a. The second rear cushioning material 131b is arranged to protrude rearward from a rear surface of the rotary body holding part 131 toward the bearing support part 107. As shown in FIG. 3, two such second rear cushioning materials 131b are symmetrically disposed with respect to the axis of the intermediate shaft 116 in a section perpendicular to the axis of the intermediate shaft 116. In other words, the first rear cushioning materials 107a and the second rear cushioning materials 131b are disposed between the bearing support part 107 which forms part of the gear housing 105 and the rotary body holding part 131 which forms part of the striking mechanism part. The second rear cushioning material 131b is an example embodiment that corresponds to the “cushioning member” according to the present invention.

As shown in FIGS. 1, 4 and 5, when the striking mechanism part (the motion converting mechanism 120, the striking mechanism 140 and the tool holder 159) is held in the front position by the biasing force of the coil spring 171, the cylinder 129 is held in contact with the bearing 129a and the front flange 132a is held in contact with the front cushioning material 108a.

[Structure of the Rotation Transmitting Mechanism]

As shown in FIG. 2, the rotation transmitting mechanism 150 mainly includes a gear speed reducing mechanism having a plurality of gears such as a first gear 151 which is fitted onto the intermediate shaft 116, and a second gear 153 which engages with the first gear 151. The second gear 153 is fitted onto the cylinder 129 and transmits rotation of the first gear 151 to the cylinder 129. When the cylinder 129 is rotated, the tool holder 159 integrally connected to the cylinder 129 is rotated. As a result, the hammer bit 119 held by the tool holder 159 is rotationally driven. Specifically, the rotation transmitting mechanism 150 rotationally drives the hammer bit 119 held by the tool holder 159.

As shown in FIG. 2, the first gear 151 is loosely fitted onto the intermediate shaft 116. The first gear 151 is disposed between the front bearing 118a and the spline engagement part 116a, and cannot be moved in the axial direction of the intermediate shaft 116 (the longitudinal direction of the hammer drill 100). A second rotation transmitting member 163 is disposed on the rear side of the first gear 151. The second rotation transmitting member 163 is a substantially cylindrical member and has a spline groove formed in its inner circumferential surface. The spline groove has a rear region having a small inner diameter and a front region having a large inner diameter. The rear region of the spline groove of the second rotation transmitting member 163 is spline connected to the spline engagement part 116a formed in the intermediate shaft 116 which extends through the second rotation transmitting member 163. With such a structure, the second rotation transmitting member 163 is held so as to be movable in the axial direction of the intermediate shaft 116 (the longitudinal direction of the hammer drill 100) with respect to the intermediate shaft 116, and normally rotates together with the intermediate shaft 116. Further, the front region of the spline groove of the second rotation transmitting member 163 is configured to be spline connected to a rear end part of the first gear 151. Thus, by spline connection, the second rotation transmitting member 163 and the first gear 151 are configured to rotate together and come in and out of contact with each other in the axial direction of the intermediate shaft 116. Specifically, as shown in FIG. 6, when the second rotation transmitting member 163 is located in a front position, the second rotation transmitting member 163 engages with the first gear 151 and rotation of the intermediate shaft 116 is transmitted to the first gear 151, so that the first gear 151 is rotated around the axis of the intermediate shaft 116. On the other hand, as shown in FIG. 7, when the second rotation transmitting member 163 is located in a rear position, the second rotation transmitting member 163 does not engage with the first gear 151 and rotation of the intermediate shaft 116 is not transmitted to the first gear 151. The second rotation transmitting member 163 is moved between the frond position and the rear position by user's operation of the changeover dial 165.

When the first gear 151 is rotationally driven, the second gear 153 engaged with the first gear 151 is rotated. Thus, the tool holder 159 connected to the cylinder 129 is rotationally driven and the hammer bit 119 held by the tool holder 159 is rotationally driven around its axis, so that the hammer bit 119 performs a drilling operation on the workpiece.

[Operation Mode Switching Mechanism]

An operation mode of the hammer drill 100 can be switched among hammer drill mode, drill mode and hammer mode. In the hammer drill mode, the hammer bit 119 performs a hammering operation by hammering motion in its axial direction and a drilling operation by rotating motion around its axis, so that a hammer drill operation is performed on the workpiece. In the drill mode, the hammer bit 119 does not perform a hammering operation by hammering motion and performs only a drilling operation by rotating motion around its axis, so that a drilling operation is performed on the workpiece. In the hammer mode, the hammer bit 119 does not perform a drilling operation by rotating motion around its axis and performs only a hammering operation by hammering motion, so that a hammering operation is performed on the workpiece.

As shown in FIGS. 6 to 8, an operation mode switching mechanism 160 is provided to switch the operation mode. The operation mode switching mechanism 160 mainly includes the first rotation transmitting member 161, the second rotation transmitting member 163, the changeover dial 165, a first change plate 167, a second change plate 168 and a compression spring 169.

The changeover dial 165 is configured to be rotatable around its axis extending in a transverse direction of the hammer drill 100 (the vertical direction as viewed in FIG. 6) which is perpendicular to the axial direction of the hammer bit 119. Further, the changeover dial 165 has a tab 165a which is manually operated by the user, and an eccentric shaft 165b which is offset (displaced) from a rotation axis of the changeover dial 165. Therefore, when the tab 165a is turned, the eccentric shaft 165b is moved in the longitudinal direction of the hammer drill 100. Specifically, the eccentric shaft 165b is placed at a rear position (as viewed in FIG. 7), a front position (as viewed in FIG. 8) or an intermediate position between the front position and the rear position (as viewed in FIG. 6) in the longitudinal direction of the hammer drill 100.

The first change plate 167 has a plate part 167A which is perpendicular to the rotation axis of the changeover dial 165, and a first engagement part 167B which extends from a rear end part of the plate part 167A in a direction of the rotation axis of the changeover dial 165 and engages with the first rotation transmitting member 161. The plate part 167A has an opening 167a which can engage with the eccentric shaft 165b. As for the length of the opening 167a in the longitudinal direction of the hammer drill 100, the length of the opening 167a shown in FIG. 6 in which the eccentric shaft 165b is located in the intermediate position is designed to be longer than the length of the opening 167a shown in FIG. 8 in which the eccentric shaft 165b is located in the front position. With such a structure, as shown in FIG. 6, an eccentric shaft retreat region 167b is provided such that the eccentric shaft 165b does not come in contact with a front edge of the opening 167a when the eccentric shaft 165b is located in the intermediate position.

The second change plate 168 has a plate part 168A which is perpendicular to the rotation axis of the changeover dial 165, and a second engagement part 168B which extends from a front end part of the plate part 168A in the direction of the rotation axis of the changeover dial 165 and engages with the second rotation transmitting member 163. The plate part 168A has an opening 168a which can engage with the eccentric shaft 165b. The opening 168a is configured to have a constant opening length in the longitudinal direction of the hammer drill 100.

The compression spring 169 is disposed between the first change plate 167 and the second change plate 168. With this structure, by the biasing force of the compression spring 169, the first change plate 167 is biased rearward and the second change plate 168 is biased forward. Further, the plate part 167A of the first change plate 167 is disposed inward of the plate part 168A of the second change plate 168 toward the intermediate shaft 116.

As shown in FIG. 6, when the eccentric shaft 165b is located in the intermediate position, the first change plate 167 and the second change plate 168 are located in the rear position and the front position, respectively, by the biasing force of the compression spring 169. As for the first change plate 167, the rear position is defined as an initial position, and as for the second change plate 168, the front position is defined as an initial position. At this time, the first rotation transmitting member 161 is placed in the rear position together with the first change plate 167 and engages with the rotary body 123. Further, the second rotation transmitting member 163 is placed in the front position together with the second change plate 168 and engages with the first gear 151. Specifically, when the eccentric shaft 165b is located in the intermediate position, the first rotation transmitting member 161 is placed in the rear position of the first rotation transmitting member 161 (also referred to as an engagement position of the first rotation transmitting member 161) and the second rotation transmitting member 163 is placed in the front position of the second rotation transmitting member 163 (also referred to as an engagement position of the second rotation transmitting member 163). In other words, when the eccentric shaft 165b is located in the intermediate position, the first rotation transmitting member 161 engages with the rotary body 123 and the second rotation transmitting member 163 engages with the first gear 151. Therefore, rotation of the intermediate shaft 116 is transmitted to the rotary body 123 and the first gear 151 via the first rotation transmitting member 161 and the second rotation transmitting member 163. As a result, the motion converting mechanism 120, the striking mechanism 140 and the rotation transmitting mechanism 150 are driven and a hammer drill operation is perfonned. Specifically, when the eccentric shaft 165b is located in the intermediate position, the hammer drill mode is selected.

As shown in FIG. 7, when the changeover dial 165 is operated to move the eccentric shaft 165b to the rear position, the eccentric shaft 165b engages with a rear edge of the opening 168a of the second change plate 168 and moves the second change plate 168 to the rear position. Specifically, the second change plate 168 is moved rearward against the biasing force of the compression spring 169 and the second rotation transmitting member 163 engaged with the second change plate 168 is moved to the rear position of the second rotation transmitting member 163. Thus, the second rotation transmitting member 163 is disengaged from the first gear 151, so that transmission of rotation of the intermediate shaft 116 to the first gear 151 is interrupted. At this time, the first rotation transmitting member 161 is held in the rear position of the first rotation transmitting member 161 while being held engaged with the rotary body 123. Specifically, when the eccentric shaft 165b is located in the rear position, the first rotation transmitting member 161 is placed in the rear position of the first rotation transmitting member 161 (the engagement position of the first rotation transmitting member 161), and the second rotation transmitting member 163 is placed in the rear position of the second rotation transmitting member 163 (also referred to as a non-engagement position of the second rotation transmitting member 163). In other words, when the eccentric shaft 165b is located in the rear position, the first rotation transmitting member 161 engages with the rotary body 123 and the second rotation transmitting member 163 does not engage with the first gear 151. Therefore, the rotation transmitting mechanism 150 is not driven, and the motion converting mechanism 120 and the striking mechanism 140 are driven, so that a hammering operation is performed. Specifically, when the eccentric shaft 165b is located in the rear position, the hammer mode is selected.

As shown in FIG. 8, when the changeover dial 165 is operated to move the eccentric shaft 165b to the front position, the eccentric shaft 165b engages with the front edge of the opening 167a of the first change plate 167 and moves the first change plate 167 to the front position. Specifically, the first change plate 167 is moved forward against the biasing force of the compression spring 169 and the first rotation transmitting member 161 engaged with the first change plate 167 is moved to the front position of the first rotation transmitting member 161. Thus, the first rotation transmitting member 161 is disengaged from the rotary body 123, so that transmission of rotation of the intermediate shaft 116 to the rotary body 123 is interrupted. At this time, the second rotation transmitting member 163 is held in the front position of the second rotation transmitting member 163 while being held engaged with the first gear 151. Specifically, when the eccentric shaft 165b is located in the front position, the first rotation transmitting member 161 is placed in the front position of the first rotation transmitting member 161 (also referred to as a non-engagement position of the first rotation transmitting member 161), and the second rotation transmitting member 163 is placed in the front position of the second rotation transmitting member 163 (the engagement position of the second rotation transmitting member 163). In other words, when the eccentric shaft 165b is located in the front position, the first rotation transmitting member 161 does not engage with the rotary body 123 and the second rotation transmitting member 163 engages with the first gear 151. Therefore, the motion converting mechanism 120 and the striking mechanism 140 are not driven, and only the rotation transmitting mechanism 150 is driven, so that a drilling operation is performed. Specifically, when the eccentric shaft 165b is located in the front position, the drill mode is selected.

As described above, in the operation mode switching mechanism 160, the changeover dial 165 is operated to switch engagement and disengagement between the first rotation transmitting member 161 and the rotary body 123 and between the second rotation transmitting member 163 and the first gear 151.

[Operation of the Striking Mechanism Part During Driving of the Hammer Drill]

In the above-described hammer drill 100, when the trigger 109a is operated and current is supplied to the electric motor 110, the motion converting mechanism 120, the striking mechanism 140 and the rotation transmitting mechanism 150 are driven based on the operation mode selected with the operation mode switching mechanism 160. As a result, the hammer bit 119 held by the tool holder 159 is driven and a prescribed operation is performed.

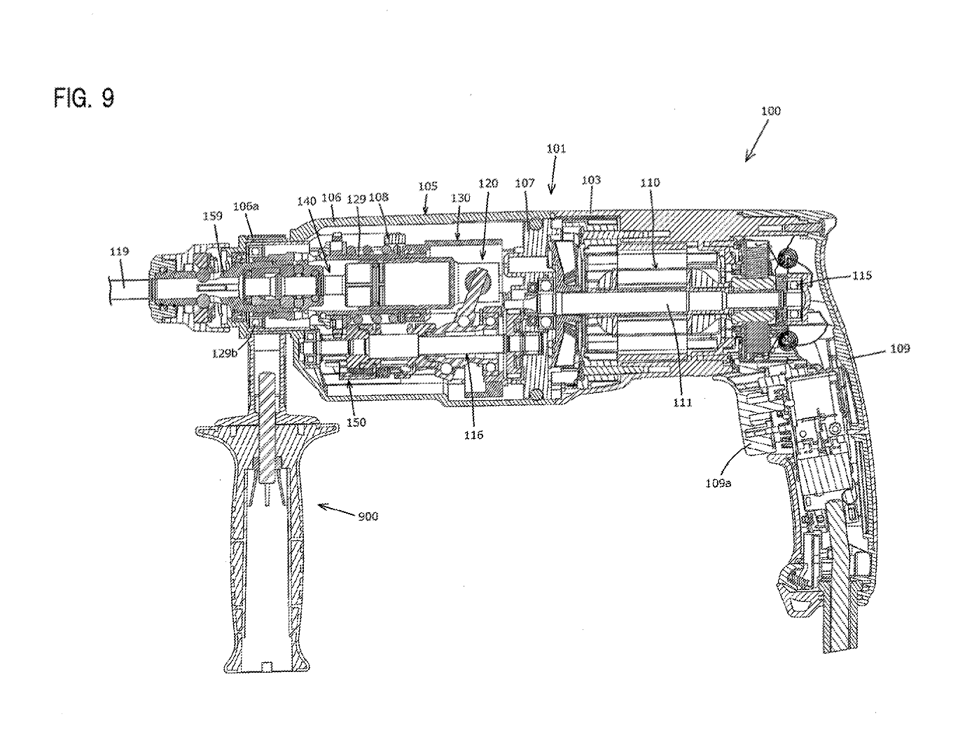

When the hammer bit 119 is pressed against the workpiece and the operation is performed, vibration is caused in the hammer drill 100 mainly in the axial direction of the hammer bit 119 by a force with which the striking mechanism part drives the hammer bit 119 and a reaction force from the workpiece which is caused by the hammering force of the hammer bit 119. By this vibration of the hammer drill 100, the striking mechanism part moves in the longitudinal direction of the hammer drill 100 along the guide shaft 170 and thus the coil spring 171 is caused to expand and contract. Specifically, during operation, the striking mechanism part moves between a front position of the striking mechanism part which is shown in FIGS. 1, 4 and 5 and a rear position of the striking mechanism part which is shown in FIGS. 9 to 11. Kinetic energy of vibration in the axial direction of the hammer bit 119 is consumed by expansion and contraction (elastic deformation) of the coil spring 117 along with movement of the striking mechanism part, so that vibration in the axial direction of the hammer bit 119 is reduced. As a result, transmission of vibration from the striking mechanism part to the body housing 101 is suppressed.

Further, as shown in FIG. 5, when the striking mechanism part moves forward in the axial direction of the hammer bit 119, the cylinder holding part 132 collides with the front cushioning material 108a provided in the guide support part 108, so that the striking mechanism part is prevented from moving further forward. As a result, the guide support part 108 and the cylinder holding part 132 are prevented from colliding with each other. Further, since the front cushioning material 108a is made of rubber, impact which is caused by collision between the cylinder holding part 132 and the front cushioning material 108a is reduced by elastic deformation of rubber.

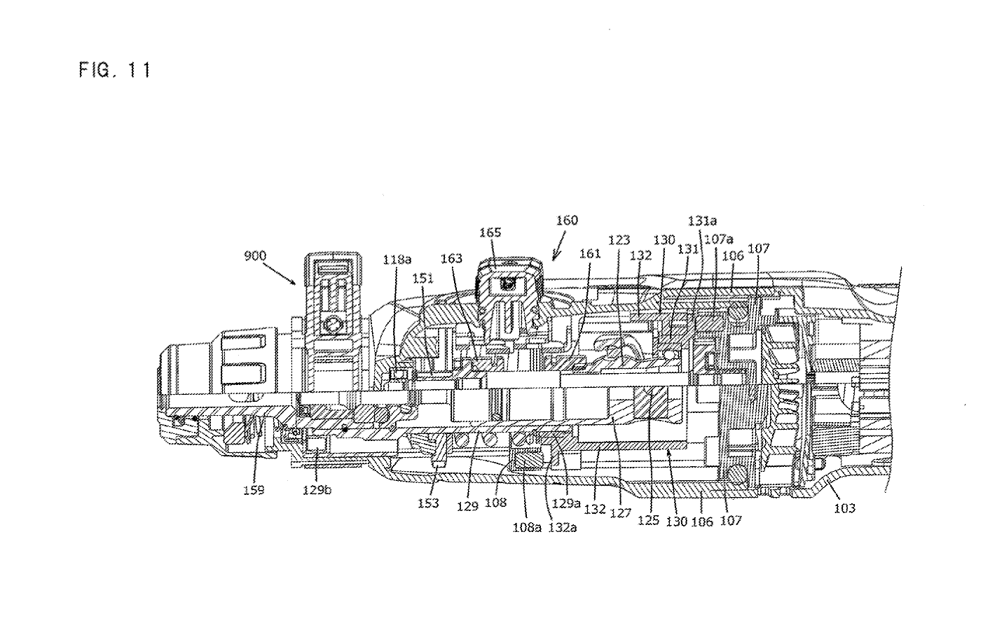

As shown in FIG. 11, when the striking mechanism part moves rearward in the axial direction of the hammer bit 119, the rotary body holding part 131 collides with the first rear cushioning material 107a provided in the bearing support part 107, so that the striking mechanism part is prevented from moving further rearward. At this time, the second rear cushioning material 131b provided in the rotary body holding part 131 collides with the bearing support part 107. As a result, the bearing support part 107 and the rotary body holding part 131 are prevented from colliding with each other. Further, since the first rear cushioning material 107a and the second rear cushioning material 131b are made of rubber, impacts which are caused by collision between the rotary body holding part 131 and the first rear cushioning material 107a and by collision between the bearing support part 107 and the second rear cushioning material 131b are reduced by elastic deformation of rubber.

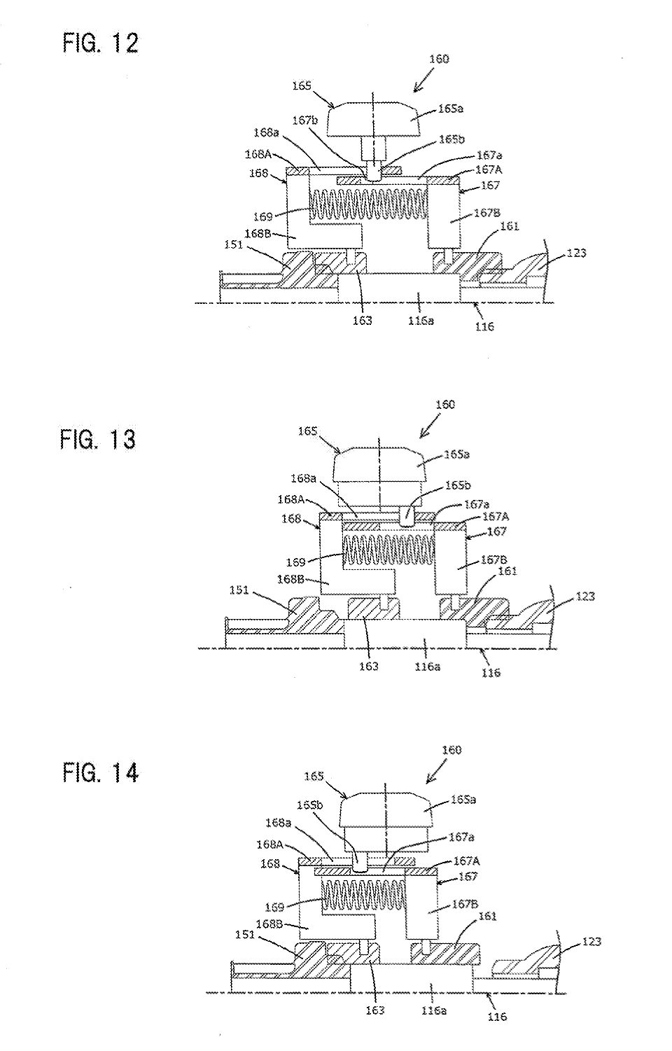

As shown in FIGS. 6 and 12, in the hammer drill mode, the first rotation transmitting member 161 engages with the rotary body 123 and rotation of the intermediate shaft 116 is transmitted to the rotary body 123. Therefore, the first rotation transmitting member 161 moves in the longitudinal direction of the hammer drill 100 together with the striking mechanism part (the rotary body 123) which moves in the longitudinal direction of the hammer drill 100, by the biasing forces of the compression spring 169 and the coil spring 171. Specifically, as shown in FIG. 6, the rotary body 123 is placed in the front position by the biasing force of the coil spring 171 (see FIG. 4). As shown in FIG. 12, when the rotary body 123 is placed in the rear position along with movement of the striking mechanism part during operation, the first rotation transmitting member 161 is moved rearward (to the right side as viewed in FIG. 12) by the biasing force of the compression spring 169. Therefore, during hammer drill operation, the first rotation transmitting member 161 and the rotary body 123 are held engaged with each other by the sliding movement of the first rotation transmitting member 161.

As shown in FIGS. 7 and 13, in the hammer mode, like in the hammer drill mode, the first rotation transmitting member 161 engages with the rotary body 123 and rotation of the intermediate shaft 116 is transmitted to the rotary body 123, so that the first rotation transmitting member 161 moves in the longitudinal direction of the hammer drill 100 together with the striking mechanism part (the rotary body 123) which moves in the longitudinal direction of the hammer drill 100. Specifically, as shown in FIG. 7, the rotary body 123 is placed in the front position by the biasing force of the coil spring 171 (see FIG. 4). As shown in FIG. 13, when the rotary body 123 is placed in the rear position along with movement of the striking mechanism part during operation, the first rotation transmitting member 161 is moved rearward (to the right side as viewed in FIG. 13) by the biasing force of the compression spring 169. Therefore, during hammering operation, the first rotation transmitting member 161 and the rotary body 123 are held engaged with each other by the sliding movement of the first rotation transmitting member 161.

As described above, in the hammer drill mode and the hammer mode, the first rotation transmitting member 161 moves in the longitudinal direction of the hammer drill 100 together with the striking mechanism part (the rotary body 123) during operation, so that engagement between the first rotation transmitting member 161 and the rotary body 123 is maintained. Specifically, in the hammer drill mode and the hammer mode, the first change plate 167 moves in the longitudinal direction of the hammer drill 100 together with the striking mechanism part.

As shown in FIGS. 8 and 14, in the drill mode, the first rotation transmitting member 161 and the rotary body 123 are held disengaged from each other. Specifically, the eccentric shaft 165b placed in the front position engages with the front edge of the opening 167a of the first change plate 167 and holds the first change plate 167 in the front position against the biasing force of the compression spring 169. Thus, the first rotation transmitting member 161 engaged with the first change plate 167 is held in the front position in which the first rotation transmitting member 161 cannot engage with the rotary body 123. Therefore, the first rotation transmitting member 161 and the rotary body 123 are held disengaged from each other. Specifically, in the drill mode, the first change plate 167 is held by the body housing 101 (the gear housing 105) without moving together with the striking mechanism part in the longitudinal direction of the hammer drill 100.

As shown in FIGS. 8 and 14, the front edge of the opening 167a of the first change plate 167 is designed to hold the first rotation transmitting member 161 such that the first rotation transmitting member 161 does not engage with the rotary body 123 in the drill mode. Specifically, it is preferable that a clearance between the eccentric shaft 165b and the front edge of the opening 167a is small when the eccentric shaft part 165a is moved from the intermediate position to the front position. Further, as shown in FIGS. 6 and 12, in the hammer drill mode, the first change plate 167 follows movement of the rotary body 123 in the longitudinal direction of the hammer drill 100 together with the first rotation transmitting member 161. Therefore, it is preferable that the clearance between the eccentric shaft 165b and the front edge of the opening 167a is large when the eccentric shaft 165b is located in the intermediate position. In order to achieve this relation of the clearance between the eccentric shaft 165b and the front edge of the opening 167a in the both modes, the eccentric shaft retreat region 167b is provided such that the eccentric shaft 165b does not come in contact with the front edge of the opening 167a when the eccentric shaft 165b is located in the intermediate position. By providing the eccentric shaft retreat region 167b, in the hammer drill mode, even when the first change plate 167 moves in the longitudinal direction of the hammer drill 100, interference between the eccentric shaft 165b and the front edge of the opening 167a is prevented. Further, as shown in FIGS. 7 and 13, in the hammer mode, since the eccentric shaft 165b is located in the rear position, a sufficient clearance is provided between the eccentric shaft 165b and the front edge of the opening 167a. Further, the eccentric shaft retreat region 167b may be additionally formed corresponding to the rear position of the eccentric shaft 165b.

According to the above-described embodiment, during hammering operation, the motion converting mechanism 120, the striking mechanism 140 and the tool holder 159 which form the striking mechanism part move in one piece with respect to the gear housing 105 (the body housing 101). At this time, vibration which is caused in the striking mechanism part in the axial direction of the hammer bit 119 by the striking force of the hammer bit 119 and the reaction force from the workpiece during the hammering operation is reduced by elastic deformation of the coil spring 171 disposed between the striking mechanism part and the gear housing 105. As a result, transmission of vibration from the striking mechanism part to the body housing 101 is reduced, so that the operability of the hammer drill 100 is improved.

The first rotation transmitting member 161 of the operation mode switching mechanism 160 is configured to move with respect to the body housing 101 so as to follow the movement of the striking mechanism part with respect to the body housing 101 during hammer drill operation and hammering operation. During drilling operation, however, the first rotation transmitting member 161 is held so as not to be movable with respect to the body housing 101. Therefore, rotation transmission to the striking mechanism part is rationally performed according to the operation mode. Further, the eccentric shaft retreat part 167b is formed in the first change plate 167 such that the eccentric shaft 165b or the operation member for operating the first rotation transmitting member 161 allows the first rotation transmitting member 161 to move along with the relative movement of the striking mechanism part when the first rotation transmitting member 161 moves with respect to the body housing 101. With this structure, when the striking mechanism part moves with respect to the body housing 101, interference between the first change plate 167 and the eccentric shaft 165b is avoided.

In the above-described embodiment, the handgrip 109 is formed in a cantilever form extending downward from the motor housing 103, but it may be shaped otherwise. For example, the handgrip 109 may be formed in a loop shape in which the distal end of the handgrip 109 is connected to the motor housing 103.

In the above-described embodiment, the output shaft 111 of the electric motor 110 is arranged to extend in parallel to the axis of the hammer bit 119, but it may be arranged otherwise. For example, the output shaft 111 of the electric motor 110 may be arranged to cross the axis of the hammer bit 119. In this case, it is preferred that the output shaft 111 and the intermediate shaft 116 are engaged with each other via a bevel gear. Further, it is preferred that the output shaft 111 is arranged perpendicularly to the axis of the hammer bit 119.

In the above-described embodiment, the pinion gear 113 and the driven gear 117 are formed as a helical gear, but they may be formed otherwise. For example, a gear such as a spur gear and a bevel gear may be used.

In the above-described embodiment, it is configured such that the striking mechanism part is driven by the intermediate shaft 116 which is driven by the electric motor 110, but it may be configured otherwise. For example, the intermediate shaft 116 may be dispensed with, and the rotary body 123 may be provided on the output shaft 111 of the electric motor 110.

In view of the nature of the above-described invention, the power tool according to this invention can be provided with the following features. Each of the features can be used separately or in combination with the other, or in combination with the claimed invention.

### (Aspect 1)

The swinging member has a rotary body that is rotationally driven around an axis of the intermediate shaft, and a swinging shaft that is connected to the rotary body and swings in the axial direction of the tool accessory,

the swinging member is spaced apart from the intermediate shaft in a radial direction of the intermediate shaft,

the impact tool has a swinging member support member that is spaced apart from the intermediate shaft in the radial direction of the intermediate shaft and supports the swinging member, and

the swinging member support member is held by a guide shaft so as to be movable in the axial direction of the tool accessory with respect to the body housing.

### (Aspect 2)

A gear for driving the driving mechanism is provided on an output shaft of the motor on a side closer to the tool accessory, and

the motor holding member is provided on a side of the gear opposite to the tool accessory in the axial direction of the tool accessory.

### (Aspect 3)

A gear that engages with the intermediate shaft and drives the intermediate shaft is provided on the output shaft of the motor on a side close to the tool accessory, and

the motor holding member is provided on a side of the gear opposite to the tool accessory in the axial direction of the tool accessory.

### (Aspect 4)

A gear that engages with a driven gear provided on the intermediate shaft and drives the intermediate shaft is provided on the output shaft of the motor, and

the gear and the driven gear engage so as not to be movable in an axial direction of the output shaft of the motor with respect to each other.

### (Aspect 5)

The gear provided on the output shaft of the motor comprises a helical gear.

### (Aspect 6)

The impact tool has a first motor bearing and a second motor bearing which support the output shaft of the motor,

the first motor bearing is arranged close to the tool accessory in the axial direction of the tool accessory,

the second motor bearing is arranged farther apart from the tool accessory than the first motor bearing,

the impact tool further has a first intermediate bearing and a second inten tediate bearing that support the intermediate shaft,

the first intermediate bearing is arranged close to the tool accessory in the axial direction of the tool accessory,

the second intermediate bearing is arranged farther apart from the tool accessory than the first intermediate bearing, and

the first motor bearing and the second intermediate bearing are held by a single member which is integrally fixed to the body housing.

### (Aspect 7)

The biasing member is disposed between the driving mechanism and the single member which holds the first motor bearing and the second intermediate bearing.

### (Aspect 8)

The impact tool has a switching device which switches between a contact state in which the rotation transmitting member comes in contact with the swinging member and a separated state in which the rotation transmitting member is separated from the swinging member, by sliding the rotation transmitting member in the axial direction of the tool accessory with respect to the intermediate shaft, and

in the contact state, the switching device holds the rotation transmitting member such that the rotation transmitting member slides together with the swinging member with respect to the intermediate shaft during operation, and in the separated state, the switching device holds the rotation transmitting member such that the rotation transmitting member does not slide with respect to the intermediate shaft during operation.

### (Aspect 9)

The switching device has an operation member that is operated by a user, and an engagement member that is engaged with the rotation transmitting member and operated with the operation member to switch the rotation transmitting member between the contact state and the separated state.

### (Correspondences Between the Features of the Embodiment and the Features of the Invention)

The above-described embodiment is a representative example for embodying the present invention, and the present invention is not limited to the constructions that have been described as the representative embodiment. Correspondences between the features of the embodiment and the features of the invention are as follow:

The hammer drill 100 is an example embodiment that corresponds to the “impact tool” according to the present invention.

The body housing 101 is an example embodiment that corresponds to the “body housing” according to the present invention.

The motor housing 103 is an example embodiment that corresponds to the “motor housing region” according to the present invention.

The gear housing 105 is an example embodiment that corresponds to the “driving mechanism housing region” according to the present invention.

The electric motor 110 is an example embodiment that corresponds to the “motor” according to the present invention.

The screw 103a is an example embodiment that corresponds to the “motor holding member” according to the present invention.

The intermediate shaft 116 is an example embodiment that corresponds to the “intermediate shaft” according to the present invention.

The holding member 130 is an example embodiment that corresponds to the “holding member” according to the present invention.

The rotary body holding part 131 is an example embodiment that corresponds to the “holding member” according to the present invention.

The cylinder holding part 132 is an example embodiment that corresponds to the “holding member” according to the present invention.

The first rotation transmitting member is an example embodiment that corresponds to the “rotation transmitting member” according to the present invention.

The rotary body 123 is an example embodiment that corresponds to the “swinging member” according to the present invention.

The swinging shaft 125 is an example embodiment that corresponds to the “swinging member” according to the present invention.

The guide shaft 170 is an example embodiment that corresponds to the “driving mechanism holding member” according to the present invention.

The guide shaft 170 is an example embodiment that corresponds to the “guide member” according to the present invention.

The coil spring 171 is an example embodiment that corresponds to the “biasing member” according to the present invention.

The front cushioning material 108a is an example embodiment that corresponds to the “cushioning member” according to the present invention.

The first rear cushioning material 107a is an example embodiment that corresponds to the “cushioning member” according to the present invention.

The second rear cushioning material 131a is an example embodiment that corresponds to the “cushioning member” according to the present invention.

The tool holder 159 is an example embodiment that corresponds to the “tool accessory holding member” according to the present invention.

The cylinder 129 is an example embodiment that corresponds to the “tool accessory holding member” according to the present invention.

The handgrip 109 is an example embodiment that corresponds to the “handle” according to the present invention.

The barrel part 106a is an example embodiment that corresponds to the “auxiliary handle mounting part” according to the present invention.

The auxiliary handle 900 is an example embodiment that corresponds to the “auxiliary handle” according to the present invention.

### DESCRIPTION OF THE NUMERALS

100 hammer drill
101 body housing
103 motor housing
103a screw
105 gear housing
106 housing part
107 bearing support part
107a first rear cushioning material
108 guide support part
108a front cushioning material
109 handgrip
109a trigger
109b power cable
110 electric motor
111 output shaft
112 fan
113 pinion gear
114 bearing
115 bearing
116 intermediate shaft
116a spline engagement part
117 driven gear
118a bearing
118b bearing
119 hammer bit
120 motion converting mechanism
123 rotary body
125 swinging shaft
127 piston
127a air chamber
129 cylinder
129a bearing
129b bearing
130 holding member
131 rotary body holding member
131a cushioning material holding part
131b second rear cushioning material
132 cylinder holding part
132a front flange
132b rear flange
133 guide through part
133a through hole
133b through hole
140 striking mechanism
143 striker
145 impact bolt
150 rotation transmitting mechanism
151 first gear
153 second gear
159 tool holder
160 operation mode switching mechanism
161 first rotation transmitting member
163 second rotation transmitting member
165 changeover dial
165a tab
165b eccentric shaft
167 first change plate
167A plate part
167B first engagement part
167a opening
167b eccentric shaft retreat region
168 second change plate
168A plate part
168B second engagement part
168a opening
169 compression spring
170 guide shaft
171 coil spring
900 auxiliary handle

1-11. (canceled)

12. An impact tool, which performs a hammering operation by driving a detachable tool accessory at least in an axial direction of the tool accessory, comprising:
a motor,
a driving mechanism that is driven by the motor and drives the tool accessory in the axial direction of the tool accessory,
a single body housing having a motor housing region for housing the motor and a driving mechanism housing region for housing the driving mechanism, and
a biasing member that is disposed between the driving mechanism and the body housing,
wherein
the motor is fixedly held in the motor housing region by a motor holding member,
the driving mechanism is held in the driving mechanism housing region by a driving mechanism holding member so as to be movable with respect to the body housing, and the driving mechanism moves with respect to the body housing under a biasing force of the biasing member, so that transmission of vibration to the body housing is reduced.

13. The impact tool as defined in claim 12, wherein:
the driving mechanism holding member has a guide member that extends in parallel to the axial direction of the tool accessory and is fixed in the driving mechanism housing region, and
the guide member guides the driving mechanism such that the driving mechanism moves in the axial direction of the tool accessory with respect to the body housing.

14. The impact tool as defined in claim 13, wherein:
the guide member comprises an elongate guide shaft, and the biasing member comprises a coil spring which is arranged coaxially with the guide member so as to overlap with at least part of the guide member in a longitudinal direction of the guide member.

15. The impact tool as defined in claim 12, wherein:
the driving mechanism has a swinging member that is driven by the motor and caused to swing in the axial direction of the tool accessory, and a striking mechanism that drives the tool accessory in the axial direction by swinging motion of the swinging member and performs the hammering operation.

16. The impact tool as defined in claim 15, wherein:
the body housing houses an intermediate shaft that is rotationally driven by the motor to drive the swinging member, arranged in parallel to the axial direction of the tool accessory and supported so as not to be movable in the axial direction of the tool accessory with respect to the body housing,
the swinging member is held so as to be movable in the axial direction of the tool accessory with respect to the intermediate shaft, and
the intermediate shaft guides the swinging member such that the swinging member moves in the axial direction of the tool accessory with respect to the body housing.

17. The impact tool as defined in claim 16, wherein:
the driving mechanism has a holding member which holds the swinging member while being spaced apart from the intermediate shaft in a radial direction of the intermediate shaft and which can move in the axial direction of the tool accessory together with the swinging member with respect to the body housing, and
the impact tool further has a rotation transmitting member that rotates together with the intermediate shaft and can come in and out of contact with the swinging member by sliding in the axial direction of the tool accessory with respect to the intermediate shaft, wherein the rotation transmitting member comes in contact with the swinging member to drive the swinging member and transmits rotation of the intermediate shaft to the swinging member.

18. The impact tool as defined in claim 17, wherein the rotation transmitting member can slide in the axial direction of the tool accessory together with the swinging member with respect to the intermediate shaft while maintaining a state in which the rotation transmitting member can transmit rotation of the intermediate shaft to the swinging member by contact with the swinging member.

19. The impact tool as defined in claim 15, comprising:
a tool accessory holding member that holds the tool accessory, wherein:
the driving mechanism has a holding member that holds the tool accessory holding member via a first bearing, holds the swinging member via a second bearing and can move in the axial direction of the tool accessory together with the tool accessory holding member and the swinging member with respect to the body housing.

20. The impact tool as defined in claim 12, wherein a cushioning member is provided between the body housing and the driving mechanism.

21. The impact tool as defined in claim 12, comprising:
a handle that is connected to the body housing and designed to be held by a user, wherein:
an auxiliary handle mounting part to which a removable auxiliary handle is mounted is further formed in the body housing.

22. The impact tool as defined in claim 12, wherein the motor is arranged such that a rotation axis of the motor extends in parallel to an axis of the tool accessory.
